(19) United States
(12) Patent Application Publication
(10) Pub. No.: US 2009/0146461 A1
(43) Pub. Date: Jun. 11, 2009

(54) MOTOR VEHICLE EQUIPPED WITH A ROOF THAT CAN BE OPENED

(75) Inventor: Tonino Gatta, Ontario (CA)

Correspondence Address: DICKINSON WRIGHT PLLC, 1875 Eye Street, NW, Suite 1200, WASHINGTON, DC, 20006, US

(73) Assignee: WEBASTO AG, Stockdorf (DE)

(21) Appl. No.: 11/813,569

(22) PCT Filed: Jan. 9, 2005
(86) PCT No.: PCT/EP05/00116

§ 371 Date: Jul. 8, 2008

(51) Int. Cl. B60J 7/06

(52) U.S. Cl. 296/193.12; 296/107.08; 296/107.18

(57) ABSTRACT

A motor vehicle equipped with a roof opening and a roof closing device that is displaceable between a closed position which closes the roof opening, and a stowed position that opens the roof opening. An additional roof closing device is provided that can close the roof opening when the roof closing device is in its stowed position. The roof closing device, in its stowed position, forms a functional assembly, in particular, at least one rear seat of the motor vehicle. The roof closing device is displaceably guided on vehicle-mounted guides mounted on longitudinal roof members on both sides of the roof opening, and on the lateral structures of the vehicle body. The roof closing device has two covers which are displaceably mounted on vehicle-mounted guides, can pivot relative to one another, and which, in the stowed position, form a seat surface or a backrest of at least one rear seat.

### BACKGROUND OF THE INVENTION

1. Field of the Invention

The invention relates to a motor vehicle with an openable roof and a roof closing means which can be moved between a closed position which closes the roof opening and a stowed position which clears the roof opening.

2. Description of Related Art

Motor vehicles of the type to which the present invention is directed are known in general. For example, European Patent Application EP 0 101 322 A2 discloses a vehicle in the manner of a notchback automobile with an openable roof which has at least one movable cover which is movably guided along roof-mounted guide rails and which can be moved between a closed position in which it covers the roof opening, and a stowed position in which it is accommodated in a holding space in the trunk lid. The back window can be supported to be able to move likewise on guides and can be displaced into the holding space in the trunk lid. In its stowed position in the holding space the stowed covers and also the back window have no useful function.

German Patent Application DE 101 31 541 A1 discloses a motor vehicle with a pivotable roof unit which is formed as a one-piece, L-shaped structure that can be moved around a fixed pivoting axis between the closed position in the roof opening and the stowed position in which it is fixed in the passenger compartment behind the front seats and forms the seat surface and backrest of at least one back seat. The one-piece, rigid, L-shaped structure of the roof unit requires a comparatively large free space for the path of its motion when pivoting. As an alternative to the fixed pivoting axis, the roof unit can be guided within a lateral guide rail from the back seats for pivoting motion. The roof unit or L-shaped structure can contain a back window since there could be a vehicle-side back window in the path of motion. To increase comfort, there can be two seat cushions which cover the inside of the back window which may be present. However, when the back seats formed by the L-shaped structure are occupied by the passengers, the roof opening can no longer be closed if necessary.

European Patent Application EP 0 803 390 A1 discloses a vehicle with a roof opening which can be closed by a roof made of slats that can be rolled up and stored in a holding space which is provided in a rear cross support. The cross support is detachably fastened to longitudinal side roof members of the vehicle roof so that it can be removed from the vehicle roof or the longitudinal side roof members when the folding roof has been opened.

### SUMMARY OF THE INVENTION

The object of the invention is to devise a motor vehicle of the initially mentioned type which is improved with respect to its possible uses.

This object is achieved in accordance with the invention in the aforementioned motor vehicle in that the roof opening can be closed by an additional roof closing means when the roof closing means is in its stowed position. The additional roof closing means makes it possible to close the roof or roof opening when the roof closing means is in the stowed position.

The additional roof closing means is especially advantageous when the roof closing means forms a functional module in its stowed position or has a useful function which otherwise would be afforded by another component. This otherwise necessary component can thus be saved. This useful function can be, for example, a partition between the passenger compartment and a space which adjoins to the rear, such as the trunk or engine compartment of a mid-engine or rear-engine vehicle.

The object is also achieved in that in its stowed position the roof closing means forms a functional module in its stowed position, and especially, at least one back seat of the vehicle. When the roof closing means is closed, the vehicle interior behind the front seats can be used as a cargo space or stowage space. This cargo space or stowage space can be used by at least one other individual who has room on at least one back seat formed by the roof closing means in its stowed position. When the back seat is occupied by an individual, if the roof opening is to be closed, for example, because of the weather, the roof closing means used by the individual as a seat is not available for this purpose. The roof opening can then still be closed by means of the additional roof closing means.

The object is also achieved in that, for the initially named motor vehicle, the roof closing means is supported to be able to move on vehicle-side guides which are located on lengthwise roof members which are located on either side of the roof opening, and on the side structures of the body. The guides which are provided along the entire path of motion ensure reliable support of the roof closing means both in the closed position on the lengthwise roof members and also in the open or stowed position in the vehicle interior.

The object is also achieved in that, in the initially named motor vehicle, the roof closing means has two covers which are supported to be able to move on vehicle-side guides, which can be pivoted relative to one another in motion along the curve of the guides and form a seating surface or a backrest of at least one back seat which in the stowed position. Subdivision of the roof closing means into at least two covers enables flexible matching of the roof closing means to the course of the guides so that, in contrast to a roof closing means formed altogether rigidly, the required path of motion for the two covers is narrower, and thus, requires less free space.

Advantageous embodiments of the motor vehicle in accordance with the invention will become apparent from combinations of at least two of the features and groups of features named above.

Advantageously, the two covers are a coupled unit which can be moved jointly between the closed position and the stowed position. The coupling takes place via articulations or hinges. Of course, there are suitable seals for mutually sealing of the covers and also for sealing the covers on the vehicle roof. On the other hand, the covers can also be individually movable, for example, by the respective drive means.

Preferably, each side guide contains a first guide section on the lengthwise roof member, a second guide section along the roof pillar and a third guide section in the floor region of the vehicle interior behind the front seats. However, the guide can also run differently from this configuration so that it can be adapted to the respective vehicle configuration and to the respective roof closing means. Here, it is advantageous if each guide is formed as a continuously running guide rail.

One preferred configuration calls for the additional roof closing means to be detachably located on the vehicle roof and especially in a compact mounting arrangement for it to be insertable by a fastening means on the lengthwise roof members and/or the roof pillars or removable therefrom.

If the additional roof closing means is permanently located on the vehicle, when opening, it can be held especially in the roof cross member or in a holding space in the body.

Furthermore, the additional roof closing means can be made as a soft top or folding convertible top and have a cross support for the convertible top for holding the opened soft top or folding convertible top and the hoops and convertible top material.

According to another embodiment, it can be provided that the additional roof closing means can be moved into the closed position which overlaps the roof closing means when the roof closing means is located in its closing position. Thus, a special effect can be achieved by the overlapping of the two roof materials.

Passenger safety is increased when there is a support means which offers additional support of the roof closing means when it is located in its stowed position, especially of the back cover. Thus, the weight of an individual sitting on the back seat is supported. Safety means, such as safety belts can likewise be integrated on the support means and also on the covers.

Furthermore, an especially upright back window can be arranged to be stationary or movable, especially with a capacity to be vertically lowered, behind the roof opening or behind the back seats. Thus, if necessary, a lowerable back window can clear the path of movement for the roof closing means if this should be necessary as a result of its arrangement.

Finally, the roof closing means and the covers can have a body-matched seat contour on the inside.

A motor vehicle in accordance with the invention is explained in detail below with reference to the accompanying drawings.

### BRIEF DESCRIPTION OF THE DRAWINGS

FIG. 1 is a perspective top view of a vehicle in accordance with the invention with an openable roof and a roof closing means which is in the closed position;

FIG. 2 is a partially broken away side view the vehicle with the roof closing means closed;

FIG. 3 is a view similar to FIG. 2 but showing the vehicle when the roof is being opened, the roof closing means being shown in a first intermediate position;

FIG. 4 is a perspective top view of the vehicle when the roof is being opened, the roof closing means being shown in a second intermediate position,

FIG. 5 is a view similar to FIG. 2 but showing the vehicle when the roof is being opened, the roof closing means being shown in a third intermediate position,

FIG. 6 is a view similar to FIG. 2 that shows the vehicle with the roof opened, the roof closing means being in its stowed position and forming back seats; and

FIG. 7 is a perspective top view of the vehicle with the stowed roof closing means and a partially opened additional roof closing means.

### DETAILED DESCRIPTION OF THE INVENTION

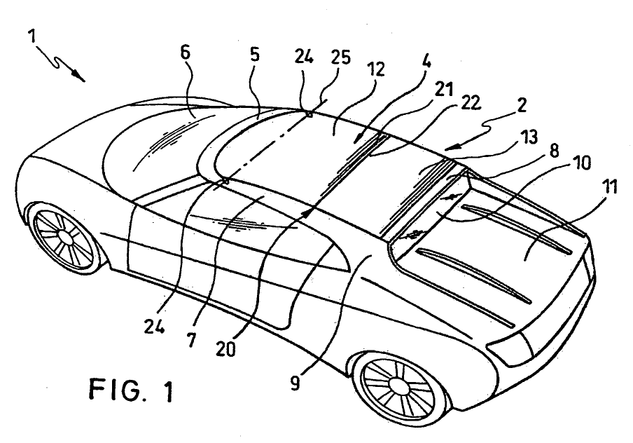

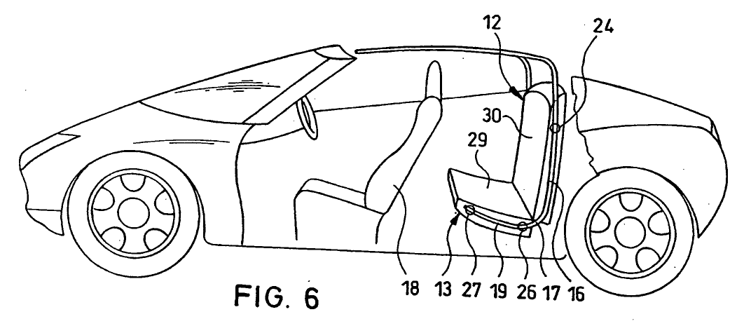

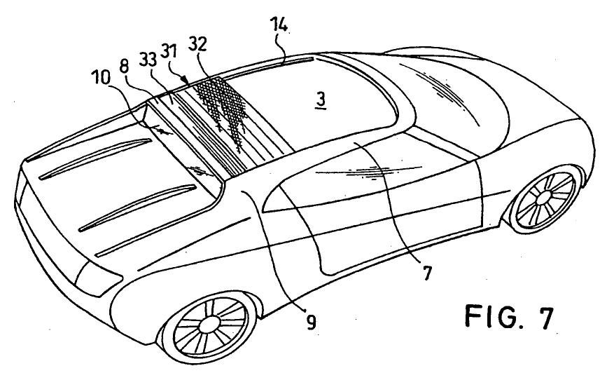

A passenger vehicle 1 contains a roof 2 (see, FIG. 1) with a roof opening 3 (FIG. 7) and a roof closing means 4 with which the roof opening 3 can be alternately closed (FIG. 1) or cleared (FIG. 6). The roof opening 3 is bordered to the front by a windshield apron 5 located above the windshield 6, laterally on each side by a longitudinal roof member 7 and to the rear by a rear cross member 8 which connects the two longitudinal roof members 7, or opposed rear roof pillars 9, to one another and are fix to it. Between the back ends of the lengthwise roof members 7, or between the roof pillars 9, there is a back window 10 which is steeply inclined or essentially upright as the termination of the vehicle interior, with an upper edge adjoining the cross member 8. The cross member 8 can also be formed by a frame of the back window 10 and can be fixed only to the back window 10 or in addition also to the roof pillars 9. The back window 10 is connected on the rear side to a fixed or movable cover 11, for example, a lid for covering the engine compartment in the case of a rear-engine vehicle and/or a trunk space.

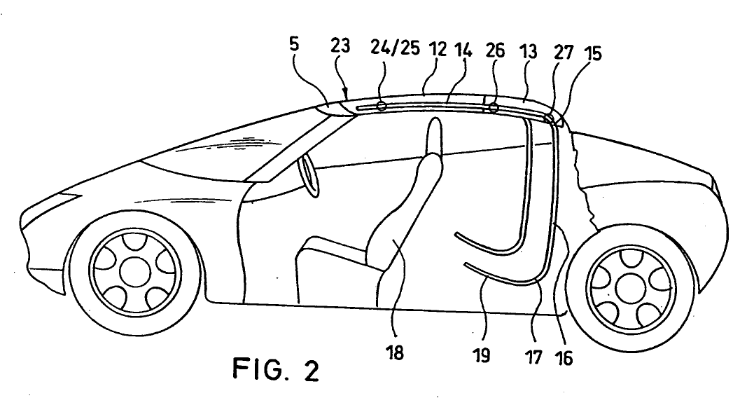

The roof closing means 4 contains a first, front cover 12 and a second, back cover 13 which closes the roof opening 3 between the apron 5 and the rear cross member 8 with the roof 2 closed. The two covers 12, 13 are movably supported on the vehicle by a cover guiding means. The cover guiding means contains a respective guide, in the form of a guide rail, on each of the two sides of the vehicle (see, FIG. 2) which in a continuously running arrangement has an essentially horizontal first guide section 14 which extends on the longitudinal roof member 7 from the apron 5 to the roof pillar 9, an adjoining, downwardly pointed first deflection section 15 on the transition from the longitudinal roof member 7 to the roof pillar 9, a second guide section 16 which runs down along the roof pillar 9 and the side body structure, a second deflection section 17 which is pointed forward and a third guide section 19 which rises slightly and which extends forward on the floor of the vehicle interior behind the front seats 18.

The two covers 12, 13 are interconnected by an articulation means 20 such as, for example, a hinge on their bordering edges, i.e., the back edge 21 of the front cover 12 and the front edge 22 of the back cover 13, so that they can be pivoted relative to one another. The first cover 12 has a bearing unit 24 on its opposing outside edges near its front edge 23. The bearing unit 24 engages on the assigned side guide, and thus, supports the first cover 12 to be able to move along the guide. The two opposite bearing units 24 are made such that the front cover 12 can be pivoted relative to the guide around a transverse axis 25 which is defined by the bearing units 24.

The back cover 13, on each of its opposing outside edges, has a front bearing unit 26 near or on its front edge 22 and a rear bearing unit 27 near or on its rear edge 28. The bearing units, which are of a known type, are shown schematically in the figures with circles, The bearing units contain, for example, a slider or carriage which is supported on the guide, with the bearing journal of the cover 12, 13, which journal is supported to be able to pivot thereon.

The drive means (not shown) can move the two covers 12, 13 along the guides 14, 15, 16, 17, 19 between the closed position and the open or stowed position. The drive means comprises, for example, an electrically or hydraulically operated drive motor which moves a drive element or drive cable which is guided along each guide and which is connected at least to one of the two covers 12, 13, for example, to the back cover 13.

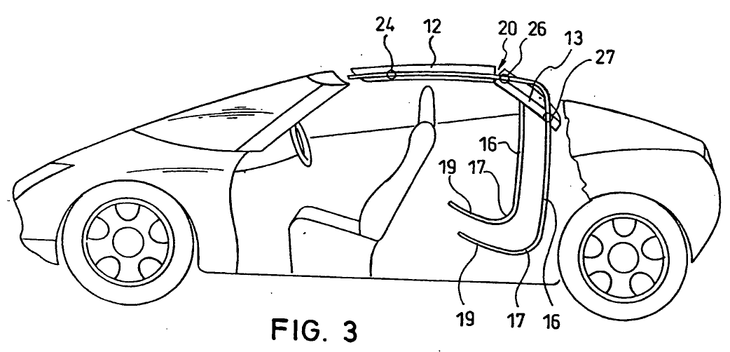

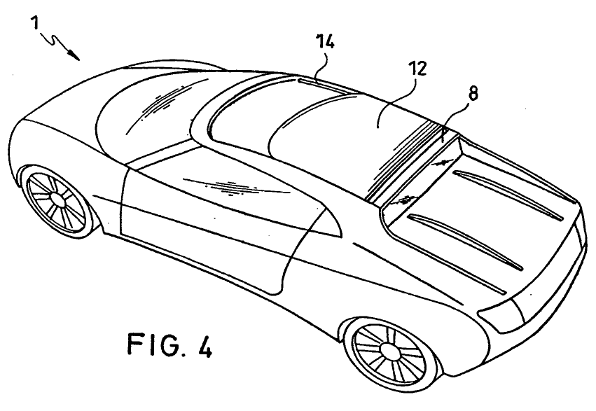

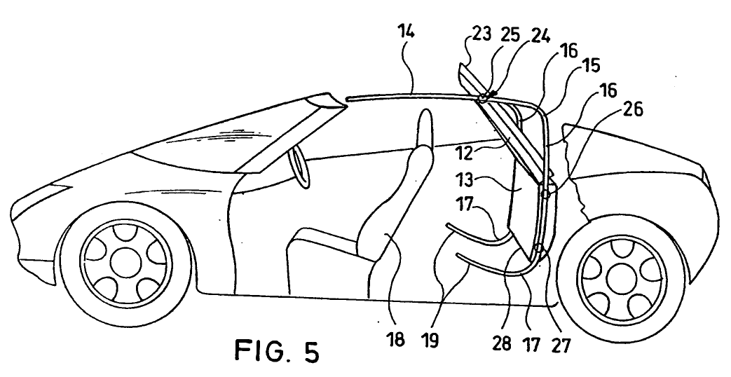

When the roof closing means 4 or the covers 12, 13 are opened, the back cover 13 moves along the guide, first its back edge 28 moving down in the region of the first deflection section 15 of the guide, and depending on the path of the guide in the region of the deflection section 15, also being able to move slightly rearwards so that the back cover 13 pivots down around its front bearing unit 26 (FIG. 3). The coupled front cover 12 is entrained and moved to the rear (FIGS. 4 & 5). Upon further movement of the two covers 12, 13, the back cover 13 reaches a vertical position during its downward motion in front of the inner side of the back window 10 (see, FIG. 5). The front cover 12 follows the back cover 13 and assumes an increasingly tilted position. Finally, the rear edge 28 of the back cover 13 follows the second deflection section 17 and is again slightly raised into the end position of the stowed position in which the motion is directed forward with respect to the vehicle so that the back cover 13 is in a horizontal position or a position inclined obliquely to the rear, in which the front edge 22 of the back cover 13 is in front of the vertical second guide section 16 (FIG. 6). The front cover 12 follows the motion of the back cover 13 and in the end position assumes a position which is slightly inclined to the rear, and in which its front edge 23 is located roughly on the upper end of the vertical second guide section 16 in front of the back window 10.

In the end position of the two covers 12, 13, the now upward and forward pointing bottom of the back cover 13 forms a seating surface 29 of a rear bench seat or of two back seats, while the bottom of the front cover 12 which now points downward and forward forms the backrest 30 of the bench seat or the two back seats.

The two covers 12, 13 have a body-shaped lining or upholstery on the bottom or they are formed, for example, as shell components with a corresponding shape which can also be visible on the top.

In this stowed position of the two covers 12, 13, a support means (not shown) on the body can be active and securely support at least the back cover 13 which forms the seat surface 29 in addition to its support on the guide so that when the back seats are loaded by passengers the back seats are securely supported.

The closing process of the two covers 12, 13 takes place by the drive means in the reverse direction. Instead of motorized driving, it can also be provided that the roof closing means and the two covers 12, 13 can be manually moved.

To close the cleared roof opening 3, there can be an additional roof closing means (see, FIG. 7) which is formed, for example, as a folding convertible top 31 formed of convertible top material 32 carried by transversely extending bows. The folding convertible top 31 has a transverse support 33 which is detachably fastened to the longitudinal roof members 7 or the roof pillars 9 in the region of the rear cross member 8, and has a holding space in which the convertible top material 32 with the bows is held when the folding convertible top 31 is opened to the rear. The folding convertible top 31 can be guided on additional guides which are located on the longitudinal roof members 7 or on the existing guides or guide sections 14 for opening and closing.

The folding convertible top 31 can also be permanently integrated on the vehicle, and for example, can be extended up out of the lower stowed position in front of or behind the back window 10. Advantageously, the convertible top material then contains a transparent viewing region which, with the convertible top closed, is essentially congruent with the back window so that it is possible to look to the rear.

The back window 10 can be fixed to the body or can be moved by a bearing means into a lowered position, for example, can be lowered on essentially vertical guide rails in order to be able to pivot around a fixed fulcrum or to pivot by means of an articulation or connecting rod means. In doing so, the rear cross member 8, with the back window 10 or independently thereof, can be removed from its position on the top edge of the back window 10.

Basically, the roof closing means can also have more than two covers. Thus, for example, two covers can form the backrest or seat surface, other combinations also being possible. There can be one back seat or even two back seats in the covers of the roof closing means.

1-11. (canceled)

12. Motor vehicle, comprising:
an openable roof,
a roof closing means which can be moved between a closed position which closes a roof opening and a stowed position which clears the roof opening, and
a roof closure arrangement which is movable for closing the roof opening when the roof closing means is located in its stowed position;
wherein the roof closing means, in its stowed position forms a functional module.

13. Motor vehicle as claimed in claim 12, wherein the functional module is at least one back seat of the vehicle.

14. Motor vehicle as claimed in claim 12, the roof closing means is supported to move on vehicle side guides which are located on longitudinal roof side members which are located on each side of the roof opening and on side structures of a body portion of the vehicle.

15. Motor vehicle as claimed in claim 12, wherein the roof closing means comprises two covers which are supported to move on vehicle side guides and are pivotable relative one another in a motion along a curved portion of the side guides and wherein the covers form a surface of at least one back seat of the vehicle in the stowed position.

16. Motor vehicle as claimed in claim 12, wherein the covers are movable individually or jointly as a coupled unit into the stowed position.

17. Motor vehicle as claimed in claim 14, wherein each side guide comprises a first guide section on a respective longitudinal roof member, a second guide section along a roof pillar and a third guide section on a floor region of the vehicle interior behind the front seats.

18. Motor vehicle as claimed in claim 14, wherein each guide is formed as a continuously running guide rail.

19. Motor vehicle as claimed in claim 12, wherein the roof closure arrangement is detachably located on the vehicle roof extending between at least one of longitudinal roof side members which are located on each side of the roof opening and roof pillars.

20. Motor vehicle as claimed in claim 12, wherein the roof closure arrangement is permanently located on the vehicle and is held in a roof cross support or in a holding space in the body in an open position thereof.

21. Motor vehicle as claimed in claim 12, wherein the roof closure arrangement is formed as a folding convertible top formed of bows and convertible top material and has a convertible top cross support for holding the folding convertible top in an open position thereof.

22. Motor vehicle as claimed in claim 12, wherein the roof closure arrangement is movable into a closed position in which the roof closure arrangement overlaps the roof closing means with the roof closing means in its closing position.

23. Motor vehicle as claimed in claim 12, wherein further comprising a support means for supporting the roof closing means in its stowed position.

24. Motor vehicle as claimed in claim 12, further comprising an upright back window arranged rearward of the roof opening.

25. Motor vehicle as claimed in claim 12, wherein the roof closing means has a body-matched seat contour on an inner side thereof.
